(19) United States
(12) Patent Application Publication
(10) Pub. No.: US 2008/0145831 A1
(43) Pub. Date: Jun. 19, 2008

(54) CLASSROOM BOOKS EVALUATION PROTOCOL

(75) Inventors: Allison Feldman, New York, NY (US); Margery Mayer, New York, NY (US)

Correspondence Address: DICKSTEIN SHAPIRO LLP, 1177 AVENUE OF THE AMERICAS (6TH AVENUE), NEW YORK, NY, 10036-2714, US

(73) Assignee: SCHOLASTIC INC., New York, NY (US)

(21) Appl. No.: 11/957,235

(22) Filed: Dec. 14, 2007

Related U.S. Application Data
(60) Provisional application No. 60/870,015, filed on Dec. 14, 2006.

(51) Int. Cl. G09B 7/00

(52) U.S. Cl. 434/353; 434/362; 434/322

(57) ABSTRACT

The present invention is a method of evaluating the content, organization, and use of a school's or a school district's classroom libraries. The method is comprised of four distinct modules or modules that collect data from administrators and classroom teachers, analyze and interpret the data, and score the schools and districts. The product of this method is a report, which is both a quantitative and qualitative representation of the quality and use of the classroom libraries in the school or across all the schools in a district, and a recommendation for improvement of the classroom libraries therein.

This application claims the benefit of Application Ser. No. 60/870,015 filed Dec. 14, 2006, which is herein incorporated by reference in its entirety.

### BACKGROUND OF THE INVENTION

Large classroom and school libraries that provide ample collections of instructional-level texts play a key role in literacy and learning. Students become fluent readers when they are given the opportunity to practice their reading skills. For most students, a library is their source of books for reading practice. Students in classrooms with well-designed classroom libraries interact more with books, spend more time reading, demonstrate more positive attitudes towards reading, and exhibit higher levels of reading achievement. The classroom library serves diverse, instructional functions, including: enlarging and extending students' literary experiences, promoting reading practice, motivating students to read, and supporting and enriching the curriculum. Students without access to a classroom library, will read less often than students with access.

Because classroom books serve a variety of functions, choosing books for the classroom is not a simple task. Books must be selected not only for their content and quality, but also for their suitability for diverse purposes and audiences. Suggested criteria for book selection include educational significance, use, appropriateness, quality, authenticity, treatment and reader appeal. The educational significance of a work includes, but is not limited to, a book's relationship to curricular standards, thematic studies, and content-area topics. Use includes, but is not limited to, the intended use of a book within a classroom context: instructional or recreational, individual or group, introduction or in depth study. Appropriateness includes, but is not limited to, the book's content, language, readability, and presentation for the age, social development, and maturity of the intended audience. Quality includes, but is not limited to, a book's literary, visual, and technical merit, awards and recognition. Balance includes, but is not limited to, a book's genre, point of view, classic and contemporary, and cultural and ethnic representation. Authenticity includes, but is not limited to, a book's accuracy, reliability, and relevance. Treatment includes, but is not limited to, a book's clarity, organization, format, presentation, lack of bias, and authority in handling the subject. Finally, render appeal includes, but is not limited to, a book's interest, purpose, text difficulty, and maturity level.

Despite the utility of classroom libraries as a literacy tool, classroom libraries are not available to the same degree in every classroom. Rather, classroom libraries vary in quality and size both across school districts and across individual schools within the same district.

### SUMMARY OF THE INVENTION

This invention relates to the field of literacy education and is, more specifically, a method of evaluating the content, organization, and use of a classroom's, school's, or a school district's libraries. The method evaluates existing libraries by surveying teachers and administrators in the school or district, compiling their responses, correlating the responses with numerical values, and interpreting these values in a report. The report provides an analysis of the library's content, organization, and use and offers recommendations that the schools and school districts can utilize to improve their libraries in these areas.

A need exists for an evaluation method to assist schools and school districts in evaluating their library's content, organization, and use and offering recommendations that the schools and school districts can utilize to build an ideal library that is specific to the needs of each classroom.

There is no model for an ideal classroom library that meets the needs of every classroom because the type of books that comprise the selection vary depending upon student-driven and school-specific factors. Student factors include at least the age of the students, the reading levels of the students, the cultural background of the students, the diversity of the interests of the students, and the students' exposure to quality literature. School factors include at least the grade-level content standards, the multi-faceted use of the books, and the number of students per class. Thus, classrooms must be evaluated on an individual basis in order to determine what would constitute an ideal library for each classroom.

The present system and method provides interested parties, including at least administrators and teachers, with a system and method for evaluating the quality and use of classroom libraries throughout a school or a school district. The proposed system method is comprised of four modules, or tools, which are utilized in sequence by groups within the schools or school districts. After utilizing all four modules, users can produce a report that a school or school district can follow to improve its classroom libraries. The four modules are an Administrator Questionnaire and Scoring Form, an Administrator Scoring Guide and Analysis Rubric, a Classroom Library Questionnaire and Scoring Rubric, and a Classroom Library Scoring Guide and Analysis Rubric.

### BRIEF DESCRIPTION OF THE DRAWINGS

FIG. 1 shows the general workflow for an embodiment the invention.

FIG. 2 is the another embodiment of the invention.

FIG. 3 is a system which can be used to practice the invention.

### DETAILED DESCRIPTION OF THE DRAWINGS

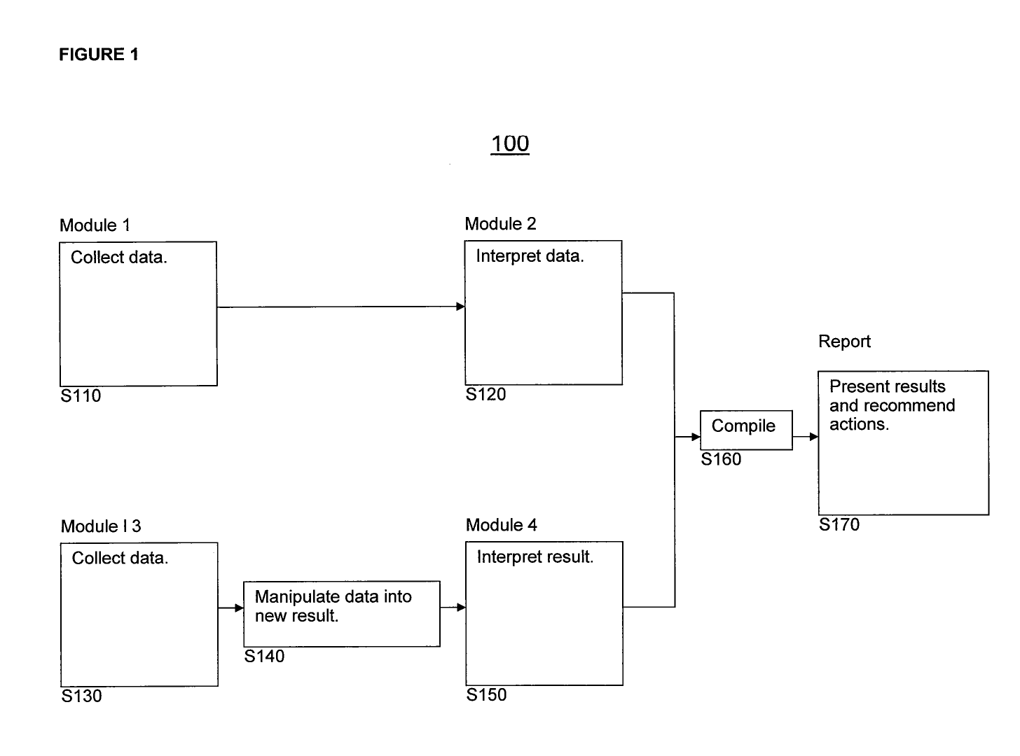

Referring to FIG. 1, the general workflow of the method 100 is shown. In this method to evaluate a classroom library, using module 1 (S110), data is collected regarding the level of financial and policy support for the library. Then, using module 2 (S120), the data gathered by module 1 (S110) is interpreted. Data is collected using module 3 (S130) regarding the contents, quality, organization and use of the library. The data is manipulated into a new result (S140), module 4 (S150) is used to interpret the new result. The output of all the modules is compiled (S160) to create a report of the results and recommendations, shown being created (S170).

In the embodiment depicted in FIG. 1, module 3 (S130) and module 1 (S110) are used concurrently, but they can also be used at different times.

Module 1 (S110) is typically comprised of an administrator questionnaire and a scoring form. APPENDIX A is one embodiment of module 1 (S110). The questionnaire portion preferably contains questions and multiple choice answers to the questions. Each answer choice on the questionnaire is assigned a numerical value. When a user completes the questionnaire portion, the scoring form is utilized to evaluate or score the answers provided. The questions in the questionnaire target the financial and policy support within the school or district for classroom libraries. The scoring form contains a formula for converting the numerical values that represent the answers into a raw score. As depicted in APPENDIX A, the questionnaire and scoring form assess at least the district's fiscal (Part I) and policy (Part II) support for classroom libraries.

In module 2 (S120) is a scoring guide and analysis rubric that associates the result generated by module 1 (S110), with an explanation of current content and recommendation for future content. APPENDIX B is one embodiment of module 2 (S120). Referring to APPENDIX B, module 2 is a guide to explain and interpret the scoring levels for Part I and Part II of the administrator's questionnaire.

Data is collected in module 3 (S130) using a classroom library questionnaire and scoring form. APPENDIX C is one embodiment of the questionnaire and scoring form of module 3 (S130). The questionnaire portion contains questions and multiple choice answers to the questions. Each answer choice on the questionnaire is assigned a numerical value. When a user completes the questionnaire portion, the scoring form is utilized to evaluate or score the answers provided. The questions in the questionnaire target the contents, quality, organization and use of the school's or the district's existing classroom libraries. The scoring form contains a formula for converting the numerical values that represent the answers into a raw score. To compute a final result for the third module, the raw scores generated by each user of the questionnaire are added together and divided by the total number of users. In the preferred embodiment, the questionnaire portion is administered to multiple teachers within a school district or an individual school. The questionnaire and scoring form in APPENDIX C assess at least the quality and content (Part I) and organization and use (Part II) of classroom libraries.

In module 4 (S150), a scoring guide and analysis rubric is used to associate the quantitative result, the raw score generated by the first module, with qualitative results, to create an expositive rating. APPENDIX D is one embodiment of the analysis rubric and scoring guide of module 4 (S150).

Referring to APPENDIX D, module 4 (S150) is a guide to explain and interpret the scoring levels for Part I and Part II of the teacher's questionnaire shown in APPENDIX C.

After all four modules are utilized, the quantitative results and the raw scores from the module 1 (S110) and module 3 (S130) are combined with the qualitative results and the expositive ratings from module 2 (S120) and module 4 (S150). The calculation is used to create an evaluation or report (S170), which is both a quantitative and qualitative representation of the quality and use of the classroom libraries in the school or across all the schools in a district, and a recommendation for improvement of the classroom libraries therein. APPENDIX E is one embodiment of this report.

The qualitative scores in the report, are aligned to both the district funding and level of policy support and the quality and use of the libraries in the classrooms surveyed. In the disclosed embodiment, the scores range from 1.0 to 7.0. The scores generally correspond to four levels and recommended actions based on the levels. Schools with classroom libraries rated Level 1, above standard, must enrich and enhance the libraries.

Schools with classroom libraries rated Level 2, standard, must supplement and expand the libraries. Schools with classroom libraries rated Level 3, below standard, must add books to improve the libraries. Schools with classroom libraries rated Level 4, sub-standard, must start to build the libraries.

The rubrics used in module 2 (S120) and modules 4 (S150) determine the scoring levels by providing indicators for each of the four levels. These rubrics serve as a blueprint for at least administrators and teachers in developing their classroom library improvement plans. By reviewing both the indicators and the scoring levels, the district or school will know what actions to take to improve the classroom libraries.

The produced report (S170) provides data regarding the content, quality, organization, and use of the existing classroom libraries within individual schools and throughout the district. The report identifies the strengths and gaps at both, but not limited to, the district and classroom levels. The data informs at least administrators as to which classroom to improve the quality and use of their classroom libraries. With at least this information, administrators can develop a data-driven, long-range, strategic plan to improve classroom libraries.

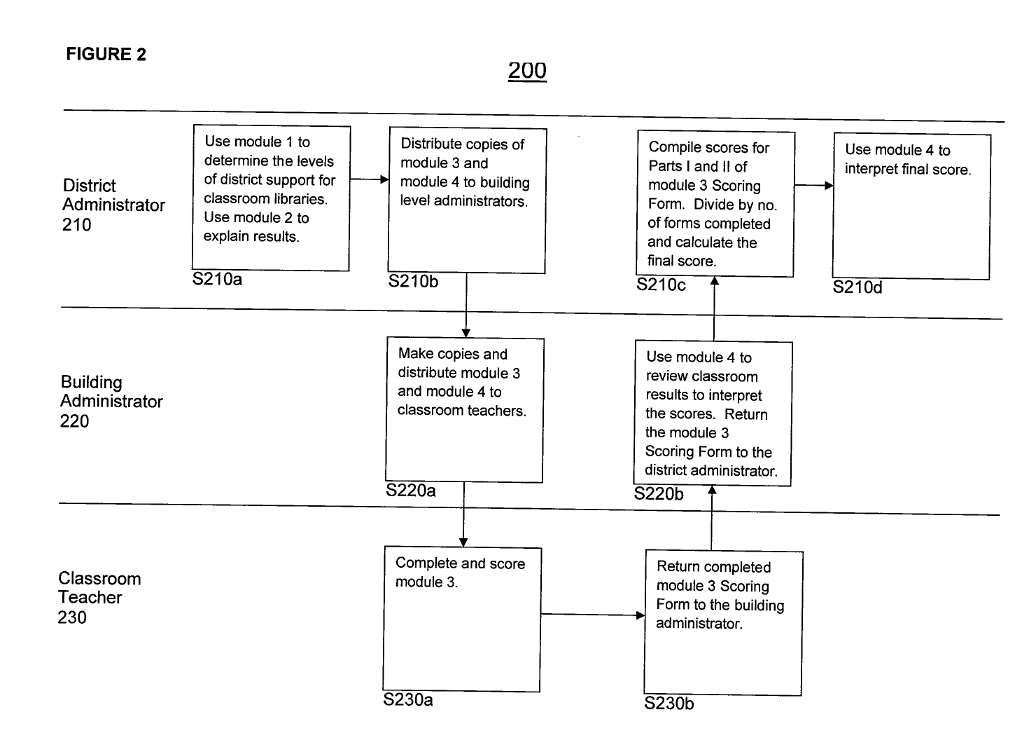

FIG. 2 depicts another embodiment of the invention 200. At least one district administrator 210, one building administrator 220, and one classroom teacher or librarian 230, participate in the evaluation. First (S210a), the district administrator 210 uses module 1 and determines the levels of support for classroom libraries and uses module 2 to explain results. Second (S210b), the district administrator 210 distributes copies of module 3 and module 4 to the building level administrator 220. Third (S220a), the building administrator 220 makes copies and distribute modules 3 and 4 to a classroom teacher or librarian 230. Fourth (S230a), the classroom teacher or librarian 230 completes and scores module 3. Fifth (S230b), the classroom teacher 230 returns the completed module 3 Scoring Form to the building administrator 220. Sixth (S220b), the building administrator 220 uses module 4 to review classroom results to interpret the scores and returns the module 3 Scoring Form to the district administrator 210. Seventh (S210c), to calculate the final score, the district administrator 210 compiles scores for Parts I and II of the module 3 Scoring Form and divides these totals by the number of forms completed. Finally (S210d), the district administrator 210 uses module 4 to interpret the final score.

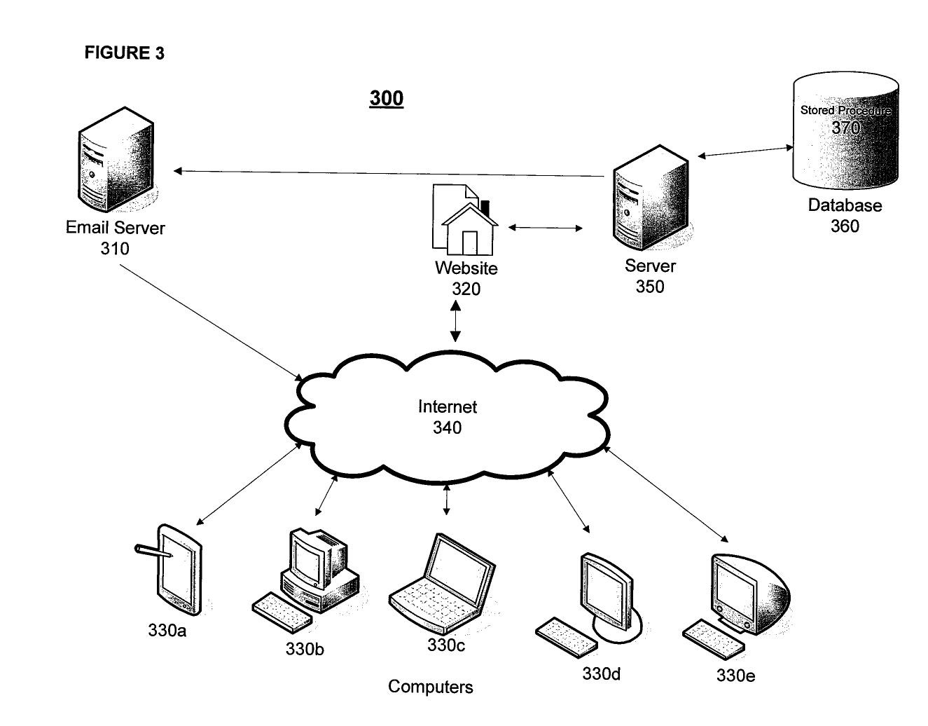

Referring to FIG. 3, the above method can be practiced using system 300. Intended users are preferably emailed credentials via an email server 310. Alternatively, these users could log on to computers to access the survey. In the embodiment of FIG. 3, users submit the credentials to a website 320 using their home, office, local internet café, etc., via computers 330a-e to access a website 320 via the Internet 340. The website has at least a server 350 and a database 360 as a back end. Once the server 350, which is running web services, 350 verifies that a user has entered the correct credentials into the website 320, the server 350, deploys the questionnaire portions of module 1 (S110) and module 3 (S130) to the user. Although the verification occurs on the server side in this embodiment, the system is not limited to this type of verification and includes any verification known in the art. Additionally, an embodiment may exist without verification should the users decide to open the surveys to the public or the survey may be emailed to the users.

After all users have completed the survey, a stored procedure 370 runs on the database 360, which calculates the raw scores, performs the translation functions of module 2 (S120) and module 4 (S150), and creates a report (S170). In one embodiment, the stored procedure 370 searches the answers for keywords in short answer questions in phrases in addition to multiple choice answers and assigns weights to the responses.

The report is preferably stored in the database 360 so users with administrative credentials may view the results on the website 320. The report may also be stored on a server or in any other way known to those skilled in the art. Additionally, the server 350 communicates with the email server 310 to email the report (S170) to a list of recipients. Text messaging, instant messaging, etc. may also be used to deliver the report to users.

Although the word modules is used to characterize the tools used to practice the invention, those skilled in the art will appreciate numerous modifications therefrom, including but not limited to the consolidation of certain modules or the use of additional modules. It is intended that the appended claims cover all such modifications and variations as fall within the true spirit of this present invention.

What we claim is:

1. A method of evaluating content of a library, comprising:
receiving data regarding the level of financial support for the library;
receiving data regarding the level of policy support for the library;
analyzing the financial support data;
analyzing the policy support data;
receiving data about the content of the library;
assigning a value to the content data;
creating a report based on the above steps regarding the content of the library.

2. A method of evaluating content of a library, comprising:
using a first module to collect data regarding the level of financial support for the library and the level of policy support for the library;
using a second module to interpret the data gathered using the first module;
using a third module to collect data about the content of the library;
manipulating the data collected by the third module into a result;
using a fourth module to interpret the result; and
creating a report by compiling the data gathered by the first module and the third module, and the interpretations by the second module and the fourth module wherein the report addresses the content of the library.

3. The method of claim 2, wherein the first module contains a questionnaire and a scoring form.

4. The method of claim 3, wherein the questionnaire comprises:
a set of questions and answers wherein each answer is associated with a value.

5. The method of claim 3, wherein the scoring form comprises:
a formula for converting the values from the questionnaire into a raw score.

6. The method of claim 2, wherein the second module contains a scoring guide and analysis rubric.

7. The method of claim 2, wherein the third module contains a questionnaire and a scoring form.

8. The method of claim 7, wherein the questionnaire comprises:
a set of questions and answers wherein each answer is associated with a value.

9. The method of claim 7, wherein the scoring form comprises:
a formula for converting the values from the questionnaire into a raw score.

10. The method of claim 2, wherein the fourth module contains a scoring guide and analysis rubric.

11. The method of claim 3, wherein the users of the questionnaire in the first module are district administrators.

12. The method of claim 7, wherein the users of the questionnaire in the third module are school teachers.

13. The method of claim 7, wherein the result is calculated by dividing the combined raw scores of all the users, by the number of total users.

14. A system for evaluating content of a library, comprising:
a module adapted to collect data regarding the level of financial support and policy support for the library;
a module adapted to interpret the financial support data and policy support data;
a module adapted to collect data about the content of the library;
a module adapted to assign a value to the content data;
a module adapted to create a report based on the above steps regarding the content of the library.

15. A system for evaluating content of a library, comprising:
means for receiving data regarding the level of financial support for the library;
means for receiving data regarding the level of policy support for the library;
means for analyzing the data regarding the level of policy support for the library;
means for receiving data about the content of the library;
means for manipulating the data about the content of the library into a result;
means for analyzing the result; and
means for creating a report based on the above steps regarding the content of the library.

16. The system of claim 14, wherein the module adapted to collect data regarding the level of financial support and policy support for the library administers a questionnaire and a scoring form.

17. The system of claim 16, wherein the questionnaire comprises:
a set of questions and answers wherein each answer is associated with a value.

18. The system of claim 16, wherein the scoring form comprises:
a formula for converting the values from the questionnaire into a raw score.

19. The system of claim 14, wherein the module adapted to interpret the financial support data and policy support data performs a scoring procedure and analysis rubric.

20. The system of claim 14, wherein the module adapted to collect data about the content also collects data regarding quality, organization and use of the library and administers a questionnaire and a scoring form.

21. The system of claim 20, wherein the questionnaire comprises:
a set of questions and answers wherein each answer is associated with a value.

22. The system of claim 20, wherein the scoring form comprises:
a formula for converting the values from the questionnaire into a raw score.

23. The system of claim 14, wherein the module adapted to assign a value to the content data performs a scoring procedure and analysis rubric.

24. A method of evaluating content of a library, comprising:
receiving data regarding the level of financial support for the library;
receiving data regarding the level of policy support for the library;
analyzing the financial support data;
analyzing the policy support data;
receiving data about the content, quality, organization, and use of the library;
assigning a value to the content, quality, organization, and use data;
creating a report based on the above steps regarding the content of the library.
